(19) United States
(12) Patent Application Publication
(10) Pub. No.: US 2024/0008532 A1
(43) Pub. Date: Jan. 11, 2024

(54) Fingerprint identification electronic cigarette rod and electronic cigarette

(71) Applicant: Meiying Xu, Dongguan (CN)

(72) Inventor: Jinghua Zhang, Fuzhou (CN)

(21) Appl. No.: 17/901,320

(22) Filed: Sep. 1, 2022

(30) Foreign Application Priority Data
Jul. 8, 2022 (CN) 202221770482.5

(51) Int. Cl. A24F 40/40; A24F 40/65; G06V 40/12; A24F 40/50

(52) U.S. Cl. CPC A24F 40/40; A24F 40/65; G06V 40/12; A24F 40/50

(57) ABSTRACT

A fingerprint identification electronic cigarette rod comprises a rod body, a fingerprint identification module, a main control module and a fixing frame the main control module is electrically coupled with the fingerprint identification module, so that when the fingerprint identification module is activated, the main control module starts the electronic cigarette; the fingerprint identification module is installed on one side of the fixing frame, the main control module is installed on, the other side of the fixing frame, and the fixing frame is installed in the rod body so that a trigger end of the fingerprint identification module extends out of the rod body. The fingerprint identification module can prevent children from smoking secretly and prevent power waste caused by accidental startup.

### FIELD OF THE INVENTION

The present invention relates to the technical field of electronic cigarettes, in particular, to a fingerprint identification electronic cigarette rod and an electronic cigarette.

### BACKGROUND OF THE INVENTION

Electronic cigarette is an electronic product that imitates cigarettes. It has the same appearance, smoke, taste and feeling as cigarettes. E-cigarette turns nicotine into steam through atomization and other means and allows users to smoke. Because of the same characteristics as ordinary cigarettes, e-cigarettes are gradually replacing traditional, cigarettes in the market or for users to quit smoking.

At present, the electronic cigarette in the market will start-up when the human finger contacts it, which is easy to cause waste of electric energy. Moreover, the electronic cigarette is small in shape and exquisite in appearance, which has a high similarity with children's toys. Children tend to mistake electronic cigarettes for toys and play with them. Due to the lack of anti touch design of existing e-cigarettes, children often start the e-cigarettes by mistake, which may waste the electric energy of the e-cigarettes, or cause children to inhale the e-cigarettes by mistake, affecting children's health.

On the other hand, there are many electronic components in the existing electronic cigarette, and in order to facilitate carrying and holding, most electronic cigarettes are designed to be small and exquisite. Therefore, the space for the installation of electronic components in the electronic cigarette is very limited, which makes the assembly of electronic components very difficult and affects the production efficiency of the electronic cigarette.

Therefore, it is necessary to design a fingerprint identification electronic cigarette rod and electronic cigarette that can prevent children from starting.

### SUMMARY OF THE INVENTION

The objection of the present invention is to provide a fingerprint identification electronic cigarette rod and an electronic cigarette that prevent children from starting, and to solve the technical problems that the existing electronic cigarette is easy to be triggered by children by mistake and is difficult to assemble and produce.

In order to achieve the above objections, the embodiment of the present invention provides a fingerprint identification electronic cigarette rod , which includes a rod body, a fingerprint identification module, a main control module and a fixing frame.

The main control module is electrically connected with the fingerprint identification module, so that when the fingerprint identification module is activated, the main control module starts the electronic cigarette.

The fingerprint identification module is installed on one side of the fixing frame, the main control module is installed on the other side of the fixing frame, and the fixing frame is installed in the rod body so that a trigger end of the fingerprint identification module extends, out of the rod body.

Optionally, the fixing frame comprises a first fixing frame and a second fixing frame installed inside the rod body. The first fixing frame and the second fixing frame abut against each other. The fingerprint identification module and the main control module are installed on the second fixing frame.

Optionally, one side of the second fixing frame is provided with a first mounting groove. The fingerprint identification module comprises a fingerprint board and a substrate connected to each other. The fingerprint board is exposed to the rod body; The substrate is mounted in, the first mounting groove.

Optionally, a groove wall of the first mounting groove is provided with a plurality of first bumps. When the substrate is mounted in the first, mounting groove, the first bump and the substrate abut against each other to fix the substrate.

Optionally, one side of the first mounting groove is provided with a dismounting port. Two sides of the dismounting port are provided with a limiting table. When the substrate is mounted in the first mounting groove, the limiting, table and the substrate are mutually abutted, thereby limiting the substrate.

Optionally, the first fixing frame comprises a mounting base and an abutting block connected to each other. The mounting base is embedded in one end of the rod body, and one end face of the mounting base is in contact with one end of the second fixing frame. The abutting block is in contact with one side surface of the second fixing frame.

Optionally, one outer wall of the mounting base is provided with a second protrusion. When the second protrusion abuts against an inner wall of the rod body when the mounting base is embedded in the rod body.

Optionally, the main control module comprises a central processor, a storage unit and a main control board. The central processor and the storage unit are installed on the main control board. The central processor and the storage unit are electrically connected, and both the central processor and the storage unit are electrically connected with the fingerprint board. The second fixing frame is provided with a second mounting groove; the main control board is installed in the second installation groove.

Optionally, the fingerprint identification electronic cigarette rod further includes a vibrating motor. The fixing frame is provided with a third mounting groove; The vibration motor is installed in the third installation groove; The vibration motor is electrically connected with the central processor.

The above-mentioned one or more technical schemes about the fingerprint identification electronic cigarette rod provided in the embodiments according to the present invention have at least one of the following, technical effects:
1. With the fingerprint identification module in, the rod body, the electronic cigarette can be started only after the user's finger contacts the fingerprint identification module and the fingerprint identification module identifies the user's fingerprint, thus avoiding the situation that children, start the electronic cigarette to smoke secretly, effectively improving the safety of the electronic cigarette for children, and preventing the users from accidentally touching the electronic cigarette to start it, causing a waste of electric energy.
2. first, install the electronic components on the fixing frame outside of the rod body, then push the fixing frame into the rod body, thereby achieving the assembly of the electronic components and the rod body. Installing the electronic components outside of the rod body, it has sufficient space for the installation and operation of the electronic components, and pushing the fixing frame with the electronic components into the rod body, it is also easy to operate, therefore, the assembly efficiency and the production efficiency of the electronic cigarette rod can be improved.

The present invention also provides an electronic cigarette, which includes the above-mentioned fingerprint identification electronic cigarette rod.

The present invention also provides an electronic cigarette, which includes the above-mentioned fingerprint identification electronic cigarette rod.

The above-mentioned one or more technical schemes about the electronic cigarette provided in the embodiments according to the present invention have at least one of the following technical effects:
since the electronic cigarette includes the above-mentioned fingerprint identification electronic cigarette rod, the electronic cigarette can also have the following advantages: prevent children from starting electronic cigarettes to smoke secretly; prevent the user from touching and starting the electronic cigarette by mistake; easy assembly and high production efficiency.

### BRIEF DESCRIPTION OF THE DRAWINGS

In order to more clearly explain the technical schemes in the embodiments of the present invention, the following will briefly introduce the embodiments or the drawings needed in the description of the prior art. It is obvious that the drawings in the following description are only some embodiments of the present invention, For those skilled in the art, other drawings may also be obtained from them without creative labour.

FIG. 1 is a cross-sectional view of a fingerprint identification electronic cigarette rod according to an embodiment in the present invention.

FIG. 2 is an enlarged view of part A in FIG. 1.

FIG. 3 is a perspective view of the second fixing frame according to an embodiment in the present invention.

FIG. 4 is a perspective view of the first fixing frame according to an embodiment in the present invention.

FIG. 5 is a perspective view of the fingerprint identification electronic cigarette rod according to an embodiment in the present invention.

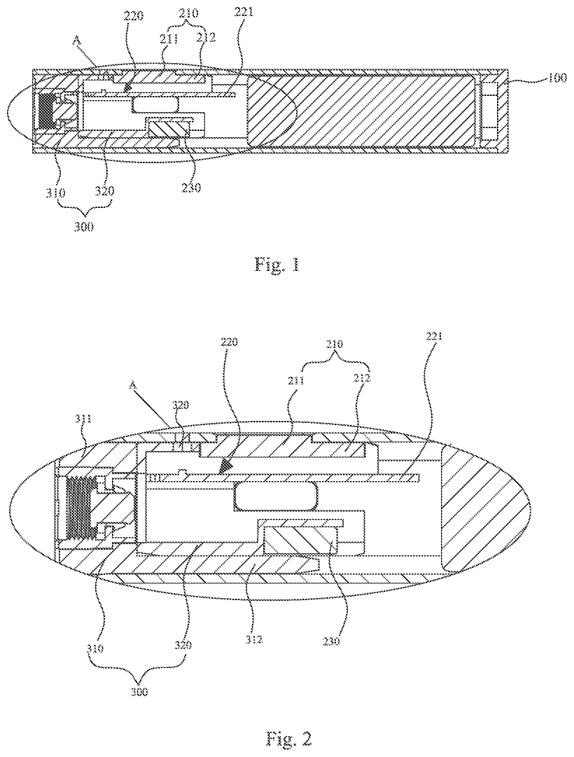

### DETAILED DESCRIPTION OF ILLUSTRATED EMBODIMENTS

The embodiments of the present invention will be described in detail below. Examples of the embodiments are shown in the drawings, where the same or similar reference numerals throughout indicate the same or similar elements or elements having the same or similar functions. The embodiments described below by referring to the accompanying drawings are exemplary and are intended to be used to explain the embodiments of the present, invention, but cannot be understood as limiting the present invention.

In the description of the embodiments of the present invention, it should be understood that the directional indications involved in the embodiments, such as the “upper”, “lower”, “left”, “right”, “front”, “rear”, “internal” and “external”, indicating orientation or location relationship, are based on the orientation or position relationship showed in the figures. These directional indications are only for describing the embodiments in the present invention and simplifying the description, rather than indicating or implying that the device or the element must be constructed and operated in a specified azimuth, which cannot be understood as a limitation of the present invention.

In addition, the terms “first” and “second” are only for descriptive purposes, and cannot be understood as indicating or implying relative importance or implicitly indicating the number of indicated technical features. Thus, the features defined as “first” and “second” may explicitly or implicitly include one or more of the features. In the description of the embodiments of the present invention, “multiple” means two or more, unless otherwise specifically defined.

In the embodiments of the present invention, unless otherwise specified and defined, the terms “installation”, “connection”, “connection”, “fixation” and other terms shall be understood in a broad sense, for example, they can be fixed connection, detachable connection, or integrated; It may be a mechanical connection or an electrical connection; It can be directly connected or indirectly connected through an intermediate medium. It can be the connection between two elements or the interaction between two elements. For those skilled in the art, the specific meanings of the above terms in the embodiments of the present invention can be understood according to specific circumstances.

In some embodiments in the present invention, referring to FIG. 1, a fingerprint identification electronic cigarette rod includes a rod body 100, a fingerprint identification module 210, a main control module 220 and a fixing frame 300. The main control module 220 is electrically coupled with the fingerprint identification module 210 so that when the fingerprint identification module 210 is activated, the main control module 220 starts the electronic cigarette. The fingerprint identification module 210 is installed on one side of the fixing frame 300, the main control module 220 is installed on the other side of the fixing, frame 300, and the fixing frame 300 is installed in the rod body 100 so that a trigger end of the fingerprint identification module 210 extends out of the rod body 100.

The fingerprint identification module 210 is arranged in the rod body 100, the electronic cigarette rod can be started only after the user's finger touches the fingerprint identification module 210 and the fingerprint identification module 210 identifies the user's fingerprint, which avoids the situation that children start the electronic cigarette to smoke secretly, and effectively improves the safety of the electronic cigarette for children.

In addition, the user has to put his finger on the fingerprint identification module 210 to maintain the startup state of the electronic cigarette rod, that is, all functions of the electronic cigarette rod, including all key functions and heating functions, require the user to put his finger on the fingerprint identification module 210 for fingerprint identification. After the fingerprint identification is successful and the user's finger remains pressed on the fingerprint identification module 210, the electronic cigarette rod can maintain normal operation. Therefore, it can prevent the user from accidentally touching the fingerprint identification module 210 and causing the electronic cigarette rod to start, resulting in waste of electric energy.

First, the fingerprint identification module 210 and the main control module 220 are installed on the fixing frame 300, and then the fixing frame 300 is pushed into the rod body 100 to realize the assembly of the fingerprint identification module 210 and the main control module 220 with the rod body 100. The fingerprint identification module 210 and the main control module 220 are installed outside of the rod body 100, and there is, sufficient space for the installation of the fingerprint identification module 210 and the main control module 220. It is also easy to push the fixing frame 300 on which the fingerprint identification module 210 and the main control module 220 are installed into the rod body 100, so the assembly efficiency of the electronic cigarette can be improved, thereby improving the production efficiency of the electronic cigarette.

In some embodiments of the present invention, referring to FIGS. 1, 3 and 4, the fixing frame 300 includes a first fixing frame 310 and a second fixing frame 320. The first fixing frame 310 is installed inside the rod body 100. The first fixing frame 310 and the second fixing frame 320 abut against each other. The second fixing frame 320 is installed inside the rod body 100. The fingerprint identification module 210 and the main control module 220 are both mounted on the second fixing frame 320.

When assembling the fingerprint identification module 210 and the main control module 220, first, install the fingerprint identification module 210 and the main control module 220 on the second fixing frame 320, then, push the second fixing frame 320 into the rod body 100, and finally, push the first fixing frame 310 into the rod body 100, the first fixing frame 310 and the second fixing frame 320 abut each other, thereby realizing mutually fixed limit.

In this embodiment, the fixing frame 300 is divided into the first fixing frame 310 and the second fixing frame 320, mainly used to install and fix the fingerprint identification module 210 and the main control module 220. After the second fixing frame 320 is completely pushed into the rod body 100 and deeply enough until the user's finger can not touch touch the second fixing frame 320, so the user can not continue pushing the second fixing frame 320 in the rod body 100. At this time, the first fixing frame 310 is pushed into the rod body 100, and the second fixing frame 320 can be indirectly pushed by the first fixing frame 310, so that the second fixing frame 320 can be installed in place. In addition, the first fixing frame 310 and the second fixing frame 320 abut against each other, so that the second fixing frame 320 can be fixed and limited, and displacement is not easily generated inside the rod body 100.

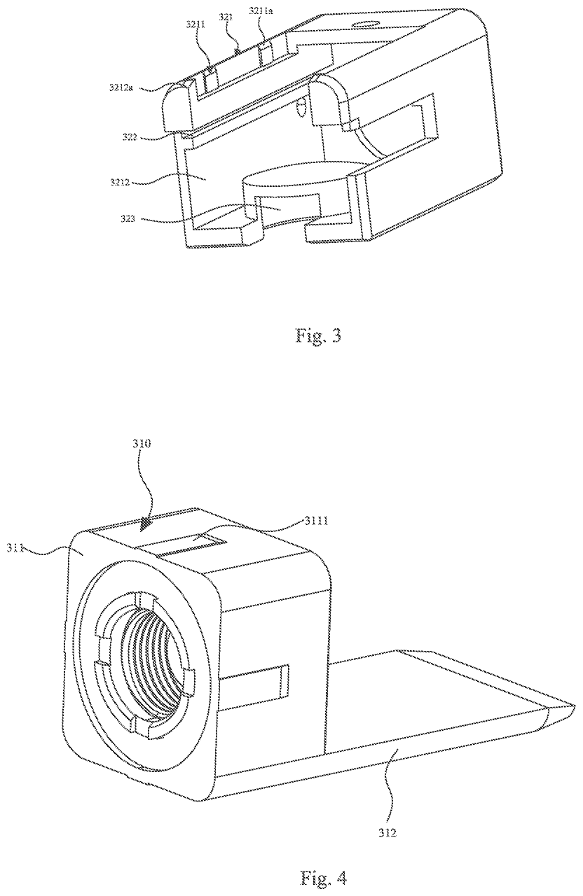

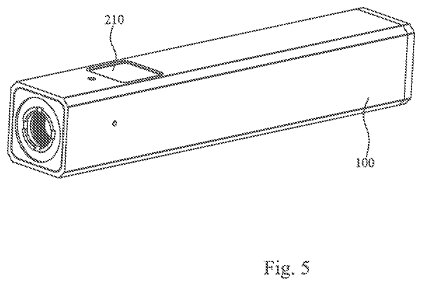

In other embodiments of the present invention, referring to FIG. 1 and FIG. 3, the second fixing frame 320 is provided with a first mounting groove 321. The fingerprint identification module 210 includes a fingerprint board 211 and a substrate 212 connected to each other. The fingerprint board 211 is exposed to the outside of the rod body 100. The substrate 212 is mounted in the first mounting groove 321. When the user performs fingerprint identification, the fingerprint board 211 exposed outside the rod body 100 is used to collect the fingerprint information of the user. In this embodiment, the fingerprint board 211 is embedded in the outer wall of the rod body 100, and the fingerprint board 211 is not easily touched by the user to cause the electronic cigarette rod to start by mistake, resulting in waste of electric energy. It should be noted that the fingerprint board 211 can also be directly mounted the outside of the rod body 100. It should be understood that, on the premise of not departing from the basic concept of the present invention, the flexible change of the mounting position of the fingerprint board 211 should be considered to be within the protection scope defined by the present invention.

In other embodiments of the present invention, as shown in FIG. 3, the first mounting groove 321 is provided with a plurality of first bumps 3211. When the substrate 212 is mounted in the first mounting groove 321, the first bump 3211 and the substrate 212 abut against each other to fix the substrate 212. When the substrate 212 is mounted in the first mounting groove 321, the first bumps 3211 and the substrate 212 abut against each other to make the substrate 212 more firmly mounted in the first mounting groove 321. In this embodiment, a chamfer 3211a is provided on the surface of the first protrusion 3211 contacting the substrate 212 to facilitate the substrate 212 to be embedded in the first mounting groove 321. It should be understood that the chamfer 3211a of the first bump 3211 is not the only embodiment. In other embodiments, the first bump 3211 may be designed into other shapes according to actual production requirements. The number and shape of the first bumps 3211 are not described in detail in the present invention. It should be understood that the flexible transformation of the specific shape and number of the first bumps 3211 should be considered within the protection scope defined by the present invention without departing from the basic concept of the present invention.

In other embodiments of the present invention, referring to FIG. 3, one side of the first mounting groove 321 is provided with a dismounting port 3212. A limiting table 3212a is provided on both sides of the dismounting port 3212. When the substrate 212 is mounted in the first mounting groove 321, the limiting table 3212a and the substrate 212 abut against each other, thereby limiting the substrate 212. Since the dismounting port 3212 is opened, there is a certain gap under the side of the substrate 212 close to the dismounting port 3212, so that it is convenient to lift the substrate 212 from bottom to top by hand, and the disassembly of the substrate 212 is more convenient.

Specifically, in this embodiment, one side of the dismounting port 3212a and the substrate 212 abut against each other, thereby preventing, the substrate 212 from sliding in the direction of the dismounting port port 3212 and falling off.

In other embodiments of the present invention, referring to FIG. 1 and FIG. 4, the first fixing frame 310 includes a mounting base 311 and an abutting block 312 connected to each other. The mounting base 311 is embedded at one end of the rod body 100, and one end of the mounting base 311 abuts against an end that is away from the opening of the second fixing frame 320. The abutting block 312 abuts against the second fixing frame 320. Specifically, when the first fixing frame 310 indirectly pushes the second fixing frame 320, one side wall of the mounting base 311 contacts the second fixing frame 320 and pushes the second fixing frame 320 deeper inside the rod body 100. When the second fixing frame 320 is in place, one side of the abutting block 312 abuts against the rod wall of the rod body 100, and the other side of the abutting block 312 abuts against the second fixing frame 320. The fixing of the second fixing frame 320 is more stable under the common abutment of the mounting base 311 and the abutting block 312.

In other embodiments of the present invention, referring to FIG. 4, the outer wall of the mounting base 311 is provided with a second protrusion 3111. When the mounting base 311 is embedded in the rod body 100, the second protrusion 3111 abuts against the inner wall of the rod body 100, thereby forming an interference fit between the mounting base 311 and the inner wall of the rod body 100, and the mounting base 311 is more stably mounted.

In other embodiments of the present invention, the main control module 220 includes a central processor (not shown), a storage unit (not shown) and a main control board 221 The central processor and the storage unit are installed on the main control board 221. The central processor is electrically coupled to the storage unit, and the central processor is also electrically connected to the fingerprint board 211. The storage unit is electrically connected to the fingerprint board 211. The second fixing frame 320 is provided with a second mounting groove 322. The main control board 221 is mounted in the second mounting groove 322.

In actual application, the storage unit is used to store fingerprint information recorded in advance by the user. When the finger of the user presses the fingerprint board 211, the fingerprint board 211 acquires the fingerprint information of the user and transmits the fingerprint information to the central processor, the central processor retrieves the fingerprint information recorded in advance in the storage unit and compares it with the fingerprint information acquired by the fingerprint board, The central processor controls the start and stop of the cigarette rod.

Specifically, in this embodiment, the central processor selects S3C2440 or other chips of the same type, and the memory unit can select a memory card or other memories of the same type. It should be noted that those skilled in the art should know and master how to connect the central processing unit and the storage unit to realize mutual data communication, and this is not the focus of this application, so it is not detailed here.

In other embodiments of the present invention, referring to FIG. 1, the fingerprint identification electronic cigarette rod further comprises a vibration motor. The fixing frame is provided with a third mounting groove. The vibration motor is installed in the third installation groove. The vibration motor is electrically connected with the central processor.

Specifically, the vibration motor 230 vibrates when the electronic cigarette operates to remind the user of the operating state of the electronic cigarette.

In actual use, the finger of the user touches the fingerprint board 211. The fingerprint board 211 transmits the collected fingerprint information to the main control module 220. The main control module 220 identifies the fingerprint information. When the fingerprint information is correct, the main control module 220 controls the electronic cigarette stick to power on. During the operation of the electronic cigarette stick, the vibration motor 230 vibrates. It should be understood that how the main control module 220 receives the fingerprint information collected by the fingerprint board 211 and how the main control module 220 controls the operation of the electronic cigarette should be well known and mastered by those skilled in the art, and are not the focus of this application, so they will not be detailed here.

The embodiment of the present invention also provides an electronic cigarette that is easy to assemble, and the electronic cigarette includes the above-mentioned fingerprint identification electronic cigarette rod.

Since the electronic cigarette includes the above-mentioned fingerprint identification electronic cigarette rod, the electronic cigarette can also prevent children from starting to smoke secretly and can also prevent the use from accidentally touching and starting, and has the characteristics of easy assembly and high production efficiency.

The above is only the preferred embodiment of the present invention, and is not intended to limit the present invention. Any modification, equivalent replacement, and improvement made within the spirit and principle of the present, invention shall be included in the scope of protection of the present invention.

What is claimed:

1. A fingerprint identification electronic cigarette rod, comprising a rod body, further comprising:
a fingerprint identification module, used to identify a user's fingerprint and prevent said electronic cigarette rod from being started accidentally;
a main control module, electrically coupled with said fingerprint identification module, so that when said fingerprint identification module is activated, said main control module starts said electronic cigarette;
a fixing frame, said fingerprint identification module is installed on one side of said fixing frame, said main control module is installed on the other side of said fixing frame, and said fixing frame is installed in said rod body so that said trigger end of said fingerprint identification module extends out of said rod body.

2. The fingerprint identification electronic cigarette rod according to claim 1, wherein said fixing frame comprises a first fixing frame and a second fixing frame installed inside said rod body; said first fixing frame and the second fixing frame abut against each other; said fingerprint identification module and said main control module are installed on said second fixing frame.

3. The fingerprint identification electronic cigarette rod according to claim 2, wherein one side of said second fixing frame is provided with a first mounting groove; said fingerprint identification module comprises a fingerprint board and a substrate connected to each other; said fingerprint board is exposed to an outside of said rod body; said substrate is mounted in the first mounting groove.

4. The fingerprint identification electronic cigarette rod according to claim 3, wherein an groove wall of said first mounting groove is provided with a plurality of first bumps; when said substrate is mounted in said first mounting groove, said first bump and said substrate abut against each other to fix said substrate.

5. The fingerprint identification electronic cigarette rod according to claim 4, wherein one side of said first mounting groove is provided with a dismounting port; two sides of the dismounting port are provided with a limit table; when said substrate is mounted in said first mounting groove, said limiting table and said substrate are mutually abutted, thereby limiting said substrate.

6. The fingerprint identification electronic cigarette rod according to claim 2, wherein said first fixing frame comprises a mounting base and an abutting block connected to each other; said mounting base is embedded in one end of said rod body, and one end face of said mounting base is in contact with one end of said second fixing frame; said abutting block is in contact with one side surface of said second fixing frame.

7. The fingerprint identification electronic cigarette rod according to claim 6, wherein that one outer wall of the mounting base is provided with a second protrusion; when the second protrusion abuts against an inner wall of the rod body when the mounting base is embedded in the rod body.

8. The fingerprint identification electronic cigarette rod according to claim 6, wherein the main control module comprises a central processor, a storage unit and a main control board; said central processor and said storage unit are installed on said main control, board; said central processor and said storage unit are electrically connected, and both said, central processor and said storage unit are electrically connected with said fingerprint board; said second fixing frame is provided with a second mounting groove; said main control board is installed in, said second installation groove.

9. The fingerprint identification electronic cigarette rod according to claim 8, wherein further comprising a vibration motor; said fixing frame is provided with a third mounting groove; said vibration motor is installed in said third installation groove; said vibration motor is electrically connected with said central processor.

10. An electronic cigarette, wherein comprising a fingerprint identification electronic cigarette rod,
said fingerprint identification electronic cigarette rod, comprising:
a rod body:
a fingerprint identification module, used to identify a user's fingerprint and prevent said electronic cigarette rod from being started accidentally;
a main control module, electrically coupled with said fingerprint identification module, so that when said fingerprint identification module is activated, said main control module starts said electronic cigarette;
a fixing frame, said fingerprint identification module is installed on one side of said fixing frame, said main control module is installed on the other side of said fixing frame, and said fixing frame is installed in said rod body so that said trigger end of said fingerprint identification module extends out of said rod body.
